(19) United States
(12) Patent Application Publication
(10) Pub. No.: US 2015/0314746 A1
(43) Pub. Date: Nov. 5, 2015

(54) HEAD PROTECTION AIR BAG

(71) Applicant: TOYODA GOSEI CO., LTD., Kiyosu-shi (JP)

(72) Inventors: Masaaki OKUHARA, Kiyosu-shi (JP); Koji KAWAMURA, Kiyosu-shi (JP); Naoki HOTTA, Kiyosu-shi (JP); Ryosuke JINNAI, Kiyosu-shi (JP); Yoshio MIZUNO, Kiyosu-shi (JP); Jun SATO, Kiyosu-shi (JP)

(21) Appl. No.: 14/687,987

(22) Filed: Apr. 16, 2015

(30) Foreign Application Priority Data
Apr. 30, 2014 (JP) 2014-094101

(51) Int. Cl. B60R 21/20; B60R 21/235; B60R 21/232

(52) U.S. Cl. CPC B60R 21/20; B60R 21/232; B60R 21/235; B60R 2021/23542; B60R 2021/23538

(57) ABSTRACT

A head protection air bag includes: an inflating and covering part configured to be inflated to separate an inside wall and an outside wall from each other on receiving the inflating gas to cover a window; multiple mounting parts; and a connecting opening part projecting upward from an upper edge of the inflating and covering part, wherein: the mounting parts and the connecting opening part are formed separately from the inflating and covering part; a hollow woven bag part and a sewn part are arranged serially; the hollow woven bag part and the sewn bag part are sewn and connected to each other; the hollow woven bag part constitutes an upper portion of the inflating and covering part; and the hollow woven bag part has a rectangular outer shape when the inside wall and the outside wall are put on each other and are developed flat.

### CROSS-REFERENCE TO RELATED APPLICATION(S)

This application is based upon and claims the benefit of priority from Japanese Patent Application No. 2014-094101, filed on Apr. 30, 2014, the entire contents of which are incorporated herein by reference.

### BACKGROUND

1. Field of the Invention

The invention relates to a head protection air bag structured such that it is folded and stored on the vehicle-inside upper edge of a window in a vehicle, its upper edge is mounted and fixed to the body of the vehicle and, when an inflating gas from an inflator is supplied therein, it projects downward from its stored portion and thus develops and inflates in such a manner to cover the vehicle inside portion of the window.

2. Description of the Related Art

Conventionally, there is known a hollow woven head protection air bag structured such that, when its inflation is completed, its inflating and covering part for covering the vehicle inside portion of a window provides a substantially rectangular outer shape, and its mounting parts and a connecting opening part respectively projecting upward from the upper edge of the inflating and covering part are formed separately from the inflating and covering part (for example, see JP-A-2010-89544). In the head protection air bag of JP-A-2010-89544, in manufacturing, only the substantially rectangular-shaped inflating and covering part with no partially projecting portion is formed by cutting an air bag material constituted of a long sheet member in the width direction into multiple parts, whereby the air bag can be manufactured with good yield.

However, in the head protection air bag of JP-A-2010-89544, since the whole of the inflating and covering part is formed by hollow weaving, the manufacturing cost is difficult to reduce and, when mounting it onto different vehicles, the design is not easy to change.

Also, there is known a head protection bag structured such that a hollow woven bag part and a sewn bag formed by sewing a vehicle inside sheet constituting the vehicle inside wall of the bag and a vehicle outside sheet constituting the vehicle outside wall part to each other are arranged side by side in the longitudinal direction, and the two bag parts are sewn to each other into a bag-like shape (for example, see JP-A-2009-56977). In the head protection air bag of JP-A-2009-56977, since the hollow woven bag part and sewn bag part are arranged side by side, the hollow woven bag par can be used in common and the sewn bag part can be replaced according to vehicles for mounting and thus, even when mounting the air bag onto different vehicles, the design is easy to change. And, when compared with an air bag the whole of which is formed by hollow weaving, it can be manufactured inexpensively.

However, in the head protection air bag of JP-A-2009-56977, since the hollow woven bag part and sewn bag part are arranged side by side in the longitudinal direction and the hollow woven bag part occupies the whole vertical area of a portion of the air bag, when mounting the air bag onto vehicles having different window heights, the shape of the hollow woven bag part must be changed, which makes it difficult to change the design of the air bag. Also, when mounting the head protection air bag of JP-A-2009-56977 onto a vehicle having a large window height, the vertical-direction width dimension of the hollow woven bag part itself must be set large, thereby inevitably increasing the manufacturing cost. Thus, there is room for improvement in prevention of the increased manufacturing cost.

### SUMMARY

The invention aims at solving the above problems and thus it is an object of the invention to provide a head protection air bag which, even when mounting it onto a vehicle having a different window height, can be easily changed in design and can prevent the increased manufacturing cost.

According to an aspect of the invention, there is provided a head protection air bag that is folded and stored into an upper edge of a window disposed on an vehicle inside of a vehicle, an upper edge of the head protection air bag being fixed to a body of the vehicle, and the head protection air bag being developed and inflated to cover the vehicle inside of the window on receiving an inflating gas from an inflator while projecting downward from a storage portion, the head protection air bag including: an inflating and covering part configured to be inflated to separate a vehicle inside wall situated on the vehicle inside and a vehicle outside wall situated on a vehicle outside from each other on receiving the inflating gas to cover the vehicle inside of the window; multiple mounting parts projecting upward from an upper edge of the inflating and covering part for mounting the upper edge of the inflating and covering part onto the upper edge of the window; and a substantially cylindrical-shaped connecting opening part projecting upward from the upper edge of the inflating and covering part, having a leading end so opened as to enable connection of the inflator, and connectable to the inflator, wherein: the mounting parts and the connecting opening part are formed separately from the inflating and covering part and are mounted onto the inflating and covering part; a hollow woven bag part, formed by hollow weaving, and a sewn part, formed by sewing a vehicle inside sheet constituting the vehicle inside wall and a vehicle outside sheet constituting the vehicle outside wall to each other, are arranged serially in the vertical direction; the hollow woven bag part and the sewn bag part are sewn and connected to each other to form the inflating and covering part as a bag-shaped member; the hollow woven bag part constitutes an upper portion of the inflating and covering part; and the hollow woven bag part has a rectangular outer shape when the vehicle inside wall and the vehicle outside wall are put on each other and are developed flat.

In the head protection air bag of the invention, the inflating and covering part for covering the vehicle inside of the window when inflation is completed is constituted of the hollow woven bag part and sewn bag part arranged side by side in the vertical direction, and the hollow woven bag part is disposed above. That is, in the head protection air bag of the invention, when changing the shape of the air bag according to a vehicle for mounting it thereon, the sewn bag part the shape of which can be changed easily and inexpensively simply by changing the cutting dimension of the material in comparison with a hollow woven bag part constitutes the whole of the lower portion of the inflating and covering part in the longitudinal direction. Therefore, when mounting it onto a vehicle having a different window height, simply by changing the vertical-direction width dimension of the sewn bag part, the hollow woven bag part can be used in common, the design of the air bag can be changed easily to cope with such different window height and the increased manufacturing cost can be prevented. Also, in the head protection air bag of the invention, since the outer shape of the hollow woven bag part when developed flat provides a rectangular shape, the yield can be enhanced. And, in manufacturing, when weaving an air bag material constituted of a long sheet member, the width dimension (the width dimension in the vertical direction when inflation is completed) is set small. Thus, when compared with the inflating and covering part of the conventional head protection air bag, the hollow woven bag parts can be arranged serially in a large number, thereby enabling further reduction of the manufacturing cost.

Therefore, in the head protection air bag of the invention, even when the heights of the windows of vehicles for mounting the air bag thereon are different, the design can be changed easily to cope with such different window heights and the increased manufacturing cost can be prevented.

Also, in the head protection air bag of the invention, when the hollow woven bag part is structured such that, while its lower edge is superposed on the inside of the upper edge of the sewn bag part, the lower edge is sewn to the upper edge of the sewn bag part, in both the vehicle inside and outside walls, the portions situated upstream in the supply direction of the inflating gas are disposed inside. Thus, when the air bag is inflated due to supply of the inflating gas therein, the inflating gas is hard to escape from the sewn portion, thereby preferably enabling the air bag to inflate quickly.

Further, in the above-structured head protection air bag, when the vehicle inside and outside sheets of the sewn bag part are made of non-coat fabrics, preferably, the manufacturing cost of the air bag can be reduced still further, and the weight reduction of the air bag itself and the compactification of the folded air bag can be realized.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a schematic front view of a head protection air bag apparatus using a head protection air bag according to an embodiment of the invention, showing the state of the apparatus mounted on a vehicle, when viewed from inside the vehicle;

FIG. 2 is a front view of the head protection air bag of the embodiment, showing a state where it is developed flat;

FIG. 3 is a partially enlarged section view of the III-III portion of FIG. 2;

FIG. 4 is a front view of a hollow woven bag part constituting the inflating and covering part of the head protection air bag of the embodiment, showing a state where the hollow woven part is developed flat;

FIG. 5 is a schematic perspective view of the composing members of the head protection air bag of the embodiment, showing a state where they are taken apart; and

FIG. 6 is a front view of a hollow woven bag material used in a process for manufacturing the head protection air bag of the embodiment.

### DETAILED DESCRIPTION OF THE INVENTION

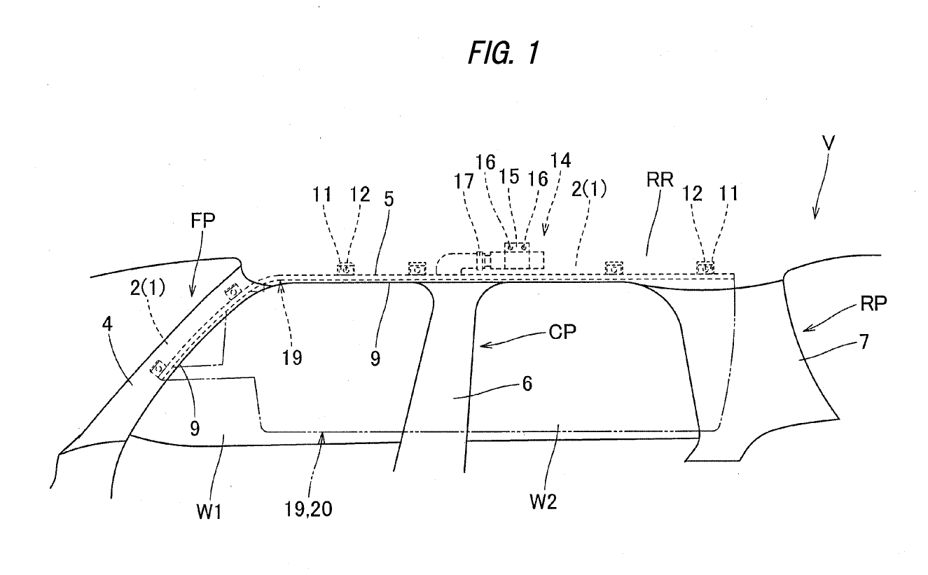

Describing below an embodiment of the invention with reference to the drawings, a head protection air bag of the embodiment (which is hereinafter called simply an air bag) 19, as shown in FIG. 1, is used in a head protection air bag apparatus M to be mounted onto a two-line seat type vehicle V having two windows (side windows) W1 and W2. The head protection air bag apparatus M includes the air bag 19, an inflator 14, mounting brackets 11, 15 and an air bag cover 9. The air bag 19, as shown in FIG. 1, is folded and stored on the vehicle-inside upper edges of the windows W1 and W2 of the vehicle V, while it extends from the lower edge of a front pillar part FP through the lower edge of a roof side rail part RR to above a rear pillar part RP.

The air bag cover 9, as shown in FIG. 1, is constituted of the respective lower edges of a front pillar garnish 4 disposed in the front pillar part FP and a roof head lining 5 disposed in the roof side rail part RR. The front pillar garnish 4 and roof head lining 5 are made of synthetic resin and, in the front pillar part FP and roof side rail part RR, are respectively mounted and fixed to the vehicle inside of an inner panel 2 provided on a body 1 (vehicle body). Also, the air bag cover 9 is structured to be openable when pressed by the air bag 19 in order that it can cover the vehicle inside of the folded and stored air bag 19 and can project the developed and inflated air bag 19 toward the vehicle inside.

The inflator 14 is used to supply an inflating gas to the air bag 19 and, as shown in FIG. 1, it is of a cylinder type having a substantially cylindrical outer shape and has a gas discharge opening (not shown) capable of discharging the inflating gas. The leading end of the inflator 14 including the vicinity of the gas discharge opening is inserted into a connecting opening part 62 (to be discussed later) of the air bag 19 and, using a clamp 17 disposed on the outer periphery of the rear end 63a of the connecting opening part 62 (connecting opening part main body 63), is connected to the air bag 19. The inflator 14, as shown in FIG. 1, is mounted on a position above the center pillar part CP of the inner panel 2 using the mounting bracket 15 for holding the inflator 14 and bolts 16 for fixing the mounting bracket 15 to the inner panel 2 provided on the body (vehicle body) 1. The inflator 14 is electrically connected through a lead wire (not shown) to the control unit (not shown) of the vehicle V.

The mounting brackets 11, each of which is constituted of two sheet-made plates, while sandwiching the respective mounting parts 66, 69a and 70a (to be discussed later) of the air bag 19, are mounted to them and mount and fix them to the inner panel 2 provided on the body 1 (see FIG. 1).

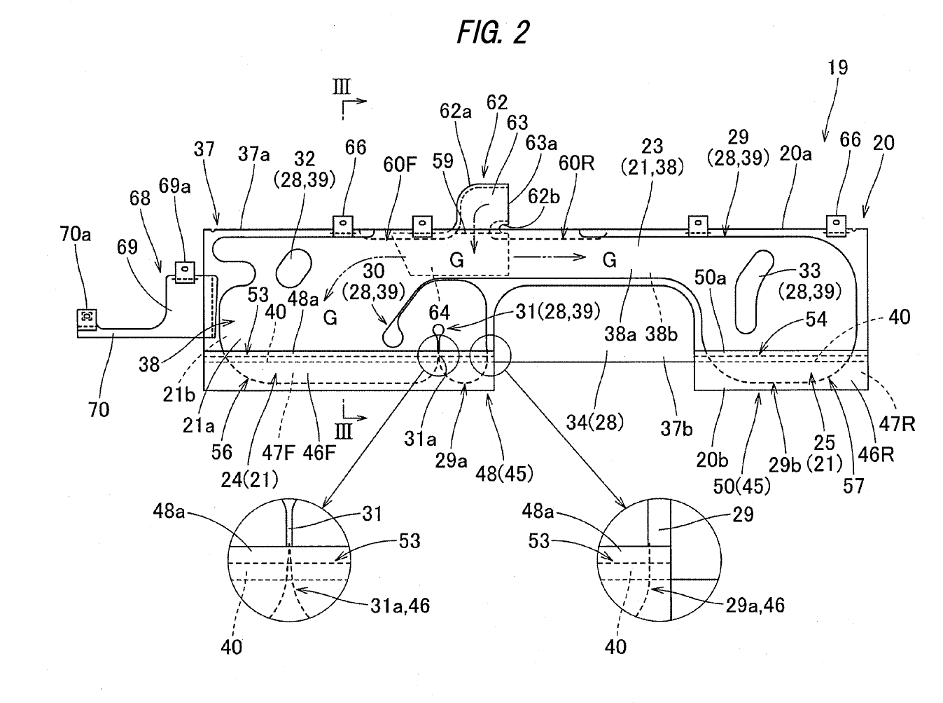

The air bag 19 is structured such that, as shown by two-dot chain lines in FIG. 1, when the inflating gas from the inflator 14 is supplied therein, can be developed from its folded state and inflated to cover the windows W1, W2, the center pillar garnish 6 of the center pillar part CP interposed between the windows W1 and W2, and the vehicle inside of the rear pillar garnish 7 of the center pillar part RP disposed behind the window W2. In the embodiment, the air bag 19, as shown in FIG. 2, includes a inflating and covering part 20 for covering the vehicle inside of the windows W1 and W2 when inflation is completed, multiple mounting parts 66 capable of projecting upward from the upper edge 20a of the inflating and covering part 20 to mount the inflating and covering part 20 onto the upper edges of the window W1 and W2, and a substantially cylindrical-shaped connecting opening part 62 capable of projecting upward from the upper edge 20a of the inflating and covering part 20. The mounting parts 66 and connecting opening part 62 are formed separately from the inflating and covering part 20. Also, the air bag 19 also includes a connecting member 68 which extends forward from the front edge of the inflating and covering part 20 and the front end of which is mounted onto the inner panel 2 provided on the body 1. This connecting member 68 is also formed separately from the inflating and covering part 20.

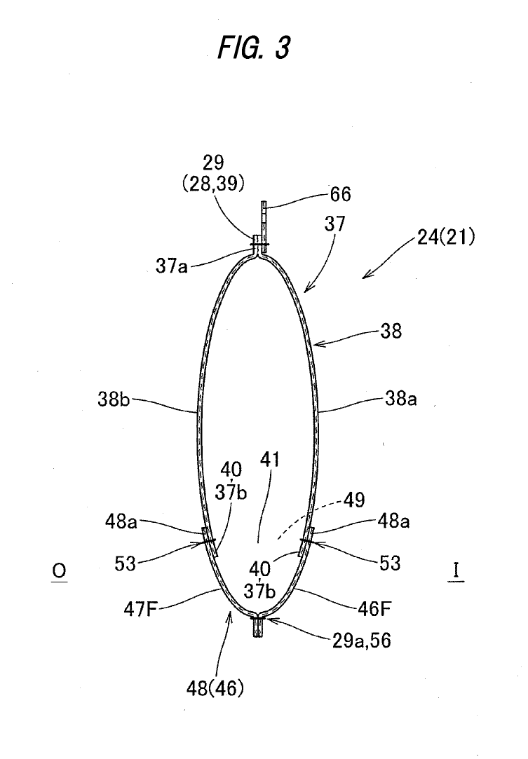

The air bag 19, as shown in FIGS. 2 and 3, includes a gas receiving part 21 capable of receiving the inflating gas G and inflating so as to separate a vehicle inside wall portion 21a to be situated on the vehicle inside I at the time of completion of inflation and a vehicle outside wall portion 21b to be situated on the vehicle outside O from each other, and a non-receiving part 28 not receiving the inflating gas G. The gas receiving part 21 includes a gas supply path part 23 constituting the inflating and covering part 20, a front seat protection part 24, a rear seat protection part 25, and connecting opening part 62.

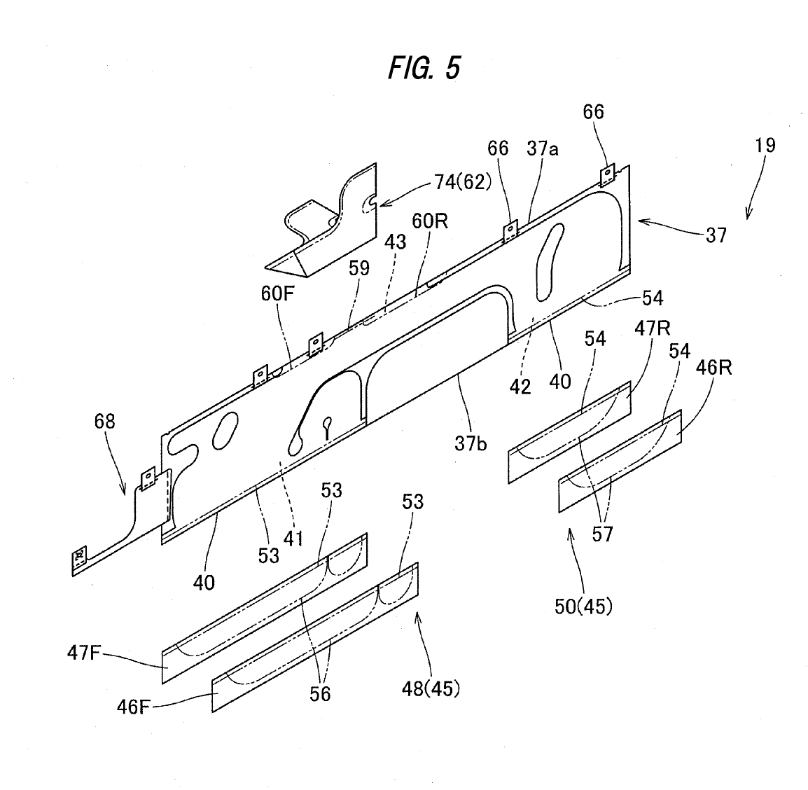

The gas supply path part 23, as shown in FIG. 2, is arranged, on the upper edge 20a side of the inflating and covering part 20, substantially over the longitudinal-direction whole area of the inflating and covering part 20 along the longitudinal direction of the vehicle V; and, it receives therein the inflating gas discharged from the inflator 14 through the connecting opening part 62 and guides it to the front seat protection part 24 and rear seat protection part 25 arranged below the gas supply part 23. In the gas supply path part 23, at a position slightly forward of the longitudinal-direction center thereof, there is arranged the connecting opening part 62 in such a manner that it communicates with the gas supply path part 23 and projects upward. The connecting opening part 62 is made of woven fabric formed of polyester threads or polyamide threads separately from the inflating and covering part 20 (gas supply path part 23). In the embodiment, the connecting opening part 62 includes an inner tube part 64 to be arranged within the gas supply path part 23, and a connecting opening part main body 63 communicating with the inner tube portion 64 and projecting upward from the gas supply path part 23. The inner tube part 64 has a substantially cylindrical-shaped portion extending along the longitudinal direction of the part 62 and has two opened front and rear ends. The connecting opening part main body 63 is bent arranged with its leading end facing backward, while its rear end 63a serving as its leading end is opened so that the inflator 14 can be connected thereto. Here, in this embodiment, a connecting opening part material 74 (see FIG. 5) connected to the lower end of the inflator 64 is two-folded and the corresponding edges except for the opening are sewn together using sewing threads (see FIG. 7), whereby the connecting opening part 62 is formed in a cylindrical shape with the rear end 63a opened.

The front seat protection part 24 is arranged to cover the vehicle inside of the window W1 situated laterally of the front seat when the air bag 19 completes its inflation, while the back seat protection part 25 is arranged to cover the vehicle inside of the window W2 existing laterally of the back seat. The front seat protection part 24 has a thickness restriction part 32 in its interior area, while the interior area is divided by dividing parts 30 and 31, whereby the thickness of the part 24 at the time of completion of inflation is restricted. The back seat protection part 25 has a thickness restriction part 33 in its interior area, thereby restricting the thickness of the part 25 at the time of completion of inflation.

The non-receiving part 28 includes a peripheral edge part 29 constituting the inflating and covering part 20, dividing parts 30, 31, thickness restriction parts 32, 33, a plate-shaped part 34, mounting parts 66 and connecting member 68. Here, in the inflating and covering part 20, the non-receiving part 28 is woven formed such that, in a hollow woven bag part 37 (to be discussed later), the vehicle inside wall part 38a (21a) and vehicle outside wall part 38b (21b) are combined with each other (see FIGS. 2 to 4) and, in a sewn bag part 45 (to be discussed later), the part 28 is constituted of sewn parts 56 and 57 which are formed such that a vehicle inside sheet 46 constituting the vehicle inside wall part 21a and a vehicle outside sheet 47 constituting the vehicle outside wall part 21b are sewn to each other (see FIGS. 2 and 3).

The peripheral edge part 29, which constitutes the outer peripheral edge of the air bag 19, is formed to surround the whole of the outer peripheries of the inflating and covering part 20 and the connecting opening part main body 63 of the connecting opening part 62. The dividing part 30, while constituting the lower edge of the gas supply path part 23, extends forward from the front upper end of the plate-shaped part 34 and is bent with its leading end directed obliquely downward, thereby dividing the gas supply path part 23 and front seat protection part 24 respectively partially. The dividing part 31 is formed such that, between the dividing part 30 and plate-shaped part 34, it extends upward from the peripheral edge part 29 constituting the lower edge of the inflating and covering part 20. The thickness restriction part 32 is arranged in the vicinity of the front end of the gas supply path part 23 and has a substantially elliptic outer shape. The thickness restriction part 33 is disposed slightly forward of the longitudinal-direction center of the back seat protection part 25 and is formed as a long part extending along the vertical direction, while its upper end is disposed within the gas supply path part 23. The plate-shaped part 34 has a substantially rectangular shape and is situated below the gas supply path part 23 between the front seat protection part 24 and back seat protection part 25.

The mounting part 66 projects upward from the upper edge 20a of the inflating and covering part 20 and multiple (in this embodiment, four) mounting parts 66 are arranged along the longitudinal direction. The mounting parts 66 are made of woven fabrics formed of polyester threads, polyamide threads or the like separately from the inflating and covering part 20 and are sewn to the peripheral edge part 29 constituting the upper edge 20a of the inflating and covering part 20 using sewing threads. The mounting parts 66 respectively have mounting holes (not shown) into which the mounting bolts 12 can be inserted. The connecting member 68 is arranged to extend forward from the front edge of the inflating and covering part 20. This connecting member 68 is also made of woven fabrics formed of polyester threads, polyamide threads or the like separately from the inflating and covering part 20. In this embodiment, the connecting member 68, as shown in FIG. 2, includes a back side portion 69 disposed on the inflating and covering part 20 side and having a substantially rectangular shape wide in the vertical direction, and, on the front side thereof, a belt portion 70 extending forward from the front lower end of the back side portion 69 substantially along the longitudinal direction. In the upper edge of the back side portion 69 and the leading end (front end) of the belt portion 70 of the connecting member 68, there are formed mounting sections 69a, 70a each having a mounting hole (not shown) into which the mounting bolt 12 can be inserted.

In this embodiment, the inflating and covering part 20 of the air bag 19 provides a substantially rectangular shape when the vehicle inside wall portion 21a and vehicle outside wall portion 21b are developed flat while they are put on each other (see FIG. 2). The inflating and covering part 20 is structured such that, also when its inflation is completed, it provides a substantially rectangular shape capable of covering the vehicle inside of the rear pillar garnish 7.

Also, in this embodiment, as shown in FIGS. 2, 3 and 5, the hollow woven bag part 37 formed by hollow weaving and the sewn bag part 45 formed by sewing together the vehicle inside sheet 46 constituting the vehicle inside wall 21a and the vehicle outside sheet 47 constituting the vehicle outside wall 21b are arranged side by side in the vertical direction and are connected to each other by sewing, whereby the inflating and covering part 20 is formed as a bag-shaped part.

The hollow woven bag part 37 is formed by hollow weaving using polyamide threads or the like and includes: an inflating portion 38 constituting the gas receiving portion 21 and, on receiving an inflating gas therein, inflatable in such a manner to separate the vehicle inside wall 38a and vehicle outside wall 38b from each other; and, a non-inflating portion 39 constituting the non-receiving portion 28 and capable of connecting together the vehicle inside and outside walls 38a and 38b. And, the outer surface (outer peripheral surface) of the hollow woven bag part 37 is covered with a coating agent made of silicone or the like for gas leakage prevention. The sewn bag part 45 is made of a non-coat woven fabric formed of polyamide threads or the like with its surface not coated by a coating agent.

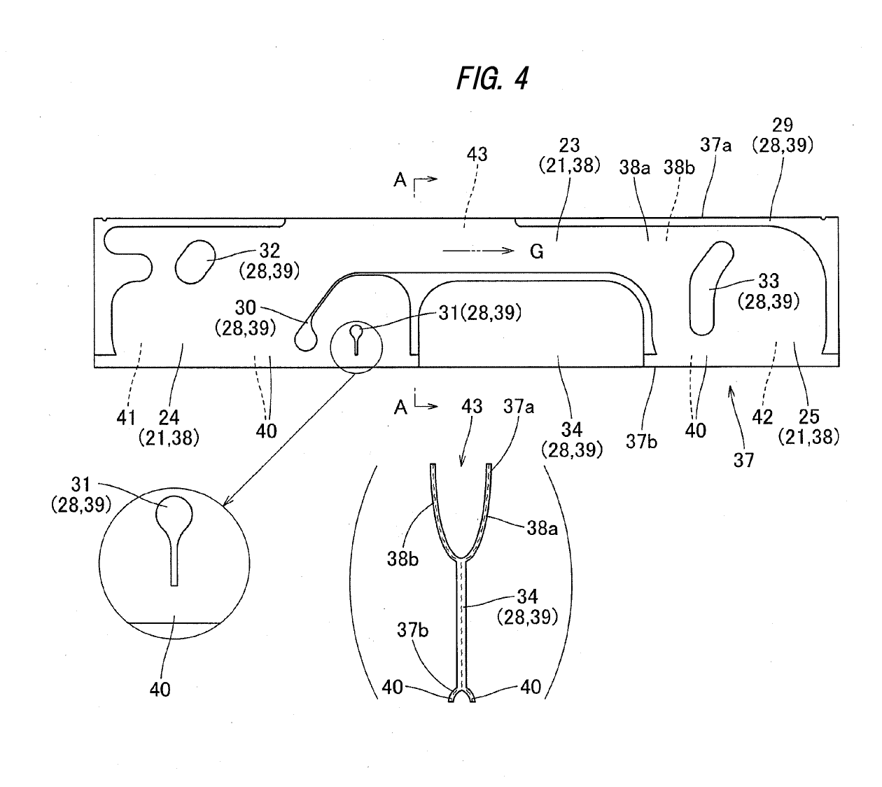

The hollow woven bag part 37, as shown in FIG. 2, constitutes the upper portion of the inflating and covering part 20 and also, as shown in FIG. 4, when it is developed in such a manner that the vehicle inside wall part 38a and vehicle outside wall part 38b are overlappingly developed flat, provides a rectangular outer shape. The lower edge 37b of the hollow woven bag part 37 can be divided to a vehicle inside wall part 38a and a vehicle outside wall part 38b except for the plate-shaped part 34 (see FIG. 4). The lower edge 37b of the hollow woven bag part 37, which is divided to the vehicle inside and outside wall parts 38a and 38b, constitutes a sewing margin 40 used to sew the upper edges 48a and 50a of the sewn bag part 45 to each other. In such portion of the hollow woven bag part 37 as constitutes the gas receiving part 21 (the portion constituting the front seat protection part 24 and back seat protection part 24), the lower edge 37b is opened continuously with the divided vehicle inside and outside wall parts 38a and 38b, (see FIGS. 3 and 4). Also, the hollow woven bag part 37 includes, on the upper edge 37a, an opening 43 through which the connecting opening part 62 can be inserted and mounted. This opening 43, as shown in FIG. 4, is opened such that, in the hollow woven bag part 37 formed by cutting a hollow woven bag material 73 (to be discussed later), the vehicle inside wall part 38a and vehicle outside wall part 38b can be divided from each other.

The sewn bag part 45, in this embodiment, as shown in FIGS. 2 and 5, includes, in the inflating and covering part 20, a front portion 48 constituting the lower portion of the front seat protection part 24 and a back portion 50 constituting the lower portion of the back seat protection part 25. The front portion 48 and back portion 50 are divided from each other in the longitudinal direction. That is, in the air bag 19 of the embodiment, the sewn bag part 45 is not arranged in the lower portion of the plate-shaped part 34. The front and back portions 48 and 50 respectively have a substantially rectangular shape the longitudinal direction of which extends along the longitudinal direction of the air bag. In this embodiment, the vertical-direction width dimension ratio of the hollow woven bag part 37 and sewn bag part 45 is set approximately for 3:1. The front and back side portions 48 and 50 constituting the sewn bag part 45 are respectively structured such that the upper edges 48a and 50a are opened. In the front side portion 48, there is formed a sewing portion 56 which, continuously with the peripheral edge 29, constitutes the front lower portion 29a of the peripheral edge 29 constituting the lower peripheral edge of the front seat protection part 24 and the lower portion 31a of the dividing part 30. The back side portion 50 includes a sewing portion 57 which, continuously with the peripheral edge 29, constitutes the back lower portion 29b of the peripheral edge 29 constituting the lower peripheral edge of the back seat protection part 25. Both ends of the respective sewing portions 56 and 57 are inserted into the peripheral edge 29 beyond sewing portions 53 and 54 which have sewn the sewing margin 40 to the respective upper edges 48a, 50a (see FIG. 2).

In this embodiment, while sewing margins 40 existing on the side of the lower edge 37b constituting the peripheral edges of the openings 41 and 42 of the hollow woven bag part 37 are respectively put on the inner portions of the upper edges 48a and 50a of the peripheral edges of the openings 49 and 51 of the front and back side portions 48 and 50 of the sewn bag part 45, the sewing margin 40 existing on the side of the lower edge 37b of the hollow woven bag part 37 is sewn to the upper edges 48a and 50a of the front and back side portions 48 and 50 using sewing threads, whereby the front and back side portions 48 and 50 of the hollow woven bag part 37 and sewn bag part 45 are connected to each other to form the bag-shaped inflating and covering part 20 (see FIG. 3). The sewing portions 53 and 54, which sew the lower edge 37b of the hollow woven bag part 37 to the upper edges 48a and 50a of the front and back side portions 48 and 50, as shown in FIG. 2, extend over the substantially entire longitudinal-direction portions of the air bag along the longitudinal direction thereof.

The opening 43 formed on the upper edge 37a of the hollow woven bag part 37 for connecting the connecting opening part 62, in a state where the connecting opening part 62 is inserted therein, as shown in FIG. 2, is closed by sewing portions 60F and 60R for sewing the vehicle inside and outside walls 38a and 38b to each other. The longitudinal-direction opening width dimension of the opening 43 is set larger than the inner tube portion 64 of the connecting opening part 62. The connecting opening part 62 is connected to the substantially longitudinal-direction central portion of the opening 43, while the longitudinal-direction other remaining portions of the opening 43 than the portion thereof with the connecting opening part 62 sewn thereto is closed because the mutually laminated vehicle inside and outside walls 38a and 38b are sewn to each other using sewing threads. The sewing portions 60F and 60R for closing the opening 43 cross a sewing part 59 which sews the connecting opening part 62 to the peripheral edge of the opening 43 and are situated slightly below the boundary between the gas supply path part 23 and peripheral edge 29. The edges of the sewing portions 60F and 60R are curved upward such that the ends thereof cross the ends of the peripheral edge 29. In this embodiment, the sewing portions 60F and 60R are continuously formed along the front edge 62a and back edge 62b of the connecting opening part 62, while sewing the front edge 62a and back edge 62b (see FIG. 2).

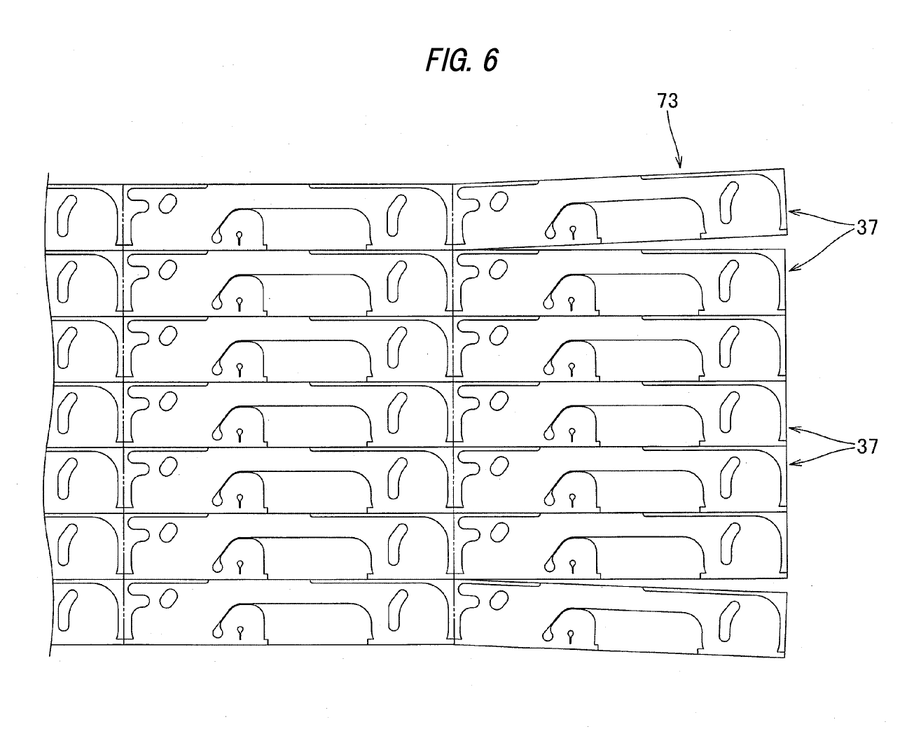

Next, description is given of a method for manufacturing the air bag 19 of the embodiment. Firstly, as shown in FIG. 6, the hollow weaving bag material 73, which is woven such that it includes multiple (in this embodiment, seven) hollow woven bag parts 37 arranged serially and the outer surface of which is coated with a coating agent, is cut to thereby form the hollow woven bag parts 37. Next, while the connecting opening part material 74 is two-folded, it is inserted into its associated hollow woven bag part 73 from an opening 43 formed in the upper edge 37a of the bag part, the portions of the hollow woven bag part 37 ranging from the opening 43 to the rear edge 2b of the connecting opening part 62 are sewn together using sewing threads to thereby form the sewn portion 60R and, similarly, the portions ranging from the opening 43 to the front edge 62a of the connecting opening part 62 are sewn together using sewing threads to thereby form the sewn portion 60F, whereby the connecting opening part 62 with its rear end 63a opened is formed and the connecting opening part 62 is connected to the hollow woven bag part 37 simultaneously. After then, the mounting parts 66 and connecting member 68 are sewn to the hollow woven bag parts 37 using sewing threads.

Next, while the respective upper edges 48a and 50a of the vehicle outside sheets 47F and 47R of the sewn bag part 45 are put on the outside (vehicle outside O) of the sewn margin 40 in the vehicle outside wall 38b of the hollow woven bag part 37, the sewn margin 40 and the upper edges 48a, 50a are sewn to each other using sewing threads to thereby form sewn portions 53, 54. Similarly, while the respective upper edges 48a and 50a of the vehicle inside sheets 46F and 46R of the sewn bag part 45 are put on the outside (vehicle inside I) of the sewn margin 40 in the vehicle inside wall 38a of the hollow woven bag part 37, the sewn margin 40 and the upper edges 48a, 50a are sewn to each other using sewing threads to thereby form sewn portions 53, 54. Next, while the vehicle inside and outside sheets 46F and 47F constituting the front side portion 48 of the sewn bag part 45 are developed flat and are put on each other, the vehicle inside and outside sheets 46F and 47F are sewn to each other using sewing threads, thereby forming the sewn portion 56 constituting the front lower portion 29a of the peripheral edge 29 and the lower portion 31a of the dividing part 31. Similarly, while the vehicle inside and outside sheets 46R and 47R constituting the back side portion 48 of the sewn bag part 45 are developed flat and are put on each other, the vehicle inside and outside sheets 46R and 47R are sewn to each other using sewing threads to form the sewn portion 57 constituting the back lower portion 29b of the peripheral edge 29, whereby the air bag 19 can be manufactured.

Next, description is given of how to mount the head protection air bag apparatus using the air bag 19 of the embodiment onto the vehicle V. Firstly, the inflating and covering part 20 of the air bag 19 with the vehicle inside and outside walls 21a and 21b put on each other and developed flat is folded together with the connecting member 68 in such a manner that the lower edge 20b approaches the upper edge 20a and the vertical-direction width dimension thereof reduces, thereby folding the air bag 19. After completion of folding of the air bag 19, the specific parts of the air bag 19 are wrapped by a breakable wrapping member for preventing the folded state against collapsing.

Next, the inflator 14 with the mounting bracket 15 mounted thereon is connected to the connecting opening part 62 of the air bag 19 using the clamp 17 and the mounting bracket 15 is fixed to the mounting parts 66, 69a and 70a, thereby forming an air bag assembly. Then, the mounting brackets 11, 15 are disposed at specific positions in the body 1 side inner panel 2 and are fixed using the bolts 12, 16, a lead wire (not shown) extending from an inflator operating specific control circuit is connected to the inflator 14, the front pillar garnish 4 and roof head lining 5 are mounted onto the body 1, and the center pillar garnish 6 and rear pillar garnish 7 are mounted onto the body 1, thereby enabling mounting of the head protection air bag apparatus M onto the vehicle V.

After the head protection air bag apparatus M is mounted onto the vehicle V, when the inflator 14 is operated, the inflating gas G discharged from the inflator 14, as shown by two-dot chain lines in FIG. 2, flows into the inflating and covering part 20, the inflating and covering part 20 of the air bag 19 breaks the wrapping member (not shown) to press open the air bag cover 9 constituted of the front pillar garnish 4 and the lower edge of the roof head lining 5 and, while projecting downward, as shown by the two-dot chain lines in FIG. 1, inflates greatly in such a manner to cover the windows W1, W2, center pillar part CP and the vehicle inside of the rear pillar part RP.

In the air bag 19 of the embodiment, the inflating and covering part 20, when inflation is completed, for covering the vehicle inside of the windows W1 and W2 includes the hollow woven bag part 37 and sewn bag part 45 arranged side by side in the vertical direction, with the hollow woven bag part 37 existing upward. That is, in the air bag 19 of the embodiment, when changing its shape according to a vehicle for mounting it thereon, the sewn bag part 45, the shape of which can be changed easily and inexpensively simply by changing the cutting dimension of its material when compared with the hollow woven part, constitutes the longitudinal-direction entire lower portion of the inflating and covering part 20. Thus, when mounting it onto vehicles having different window heights, simply by changing the vertical-direction width dimension of the sewn bag part 45, the hollow woven bag part 37 can be used in common, the design thereof can be changed to cope with this problem easily and an increase in the manufacturing cost can also be reduced. Also, in the air bag 19 of the embodiment, since the hollow woven bag part 37 is structured such that its outer shape when developed flat provides a rectangular shape, the yield can be enhanced. Also, in manufacturing, when an air bag material (hollow woven bag material 73) constituted of a long sheet member is woven, the width dimension (the vertical-direction width dimension at the time of completion of inflation) can be set small. Thus, when compared with the inflating and covering part of the conventional head protection air bag, the hollow woven bag part 37 can be arranged side by side in a larger number correspondingly to the reduced width dimension, thereby enabling further reduction of the manufacturing cost. Here, in the embodiment, as shown in FIG. 6, in the hollow woven bag material 73, there are serially arranged seven hollow woven bag parts 37. For reference, in an air bag of a conventional type that the whole of the inflating and covering part is hollow woven, in an air bag material, there are serially arranged three or four inflating and covering parts.

Therefore, in the air bag 19 of the embodiment, even when the heights of the windows of vehicles for mounting it thereon are different, the design can be changed easily according to the different heights and an increase in the manufacturing cost can be also be prevented.

Also, in the air bag 19 of the embodiment, the hollow woven bag part 37 is formed in such a manner that, while the lower edge 37b is put on the inside of the upper edges 48a and 50a of the sewn bag part 45, the lower edge 37b is sewn to the upper edges 48a and 50a of the sewn bag part 45. Thus, in both of the vehicle inside and outside walls 21a and 21b, the portions thereof situated on the upstream side in the supply direction of the inflating gas are arranged inside, whereby, when the air bag 19 inflates by supplying the inflating gas therein, the inflating gas is difficult to pass from the sewn portions 53 and 54 where the lower edge 37b and upper edges 48a, 50a are sewn to each other, thereby enabling quick inflation of the air bag 19. Of course, when such aspect is not taken into consideration, while the lower edge of the hollow woven bag part is put on the outside of the upper edge of the sewn bag part, the lower edge of the hollow woven bag part may be sewn to the upper edge of the sewn bag part.

Further, in the air bag 19 of the embodiment, since the vehicle inside and outside sheets 46 and 47 of the sewn bag part 45 are formed of non-coat fabrics, the manufacturing cost of the air bag 19 can be reduced further, and weight reduction of the air bag 19 itself and compactification of the folded air bag 19 can be realized. Especially, in the air bag 19 of the embodiment, since the sewn bag part 45 is divided to the front and back portions 48 and 50 and, in the lower portion of the plate-shaped part 34, no sewn bag part is arranged, the manufacturing cost can be reduced still further, thereby enabling further reduction of the weight of the air bag 19 and further compactification of the folded air bag 19. Here, when such aspect is not taken into consideration, the vehicle inside and outside sheets constituting the sewn bag part may be formed of coat fabrics having their outer surfaces coated with coating agent, or, without dividing to the front and back portions, the sewn bag part may be arranged to extend over the longitudinal-direction entire portion of the inflating and covering part.

Here, in the embodiment, the hollow woven bag part 37 is formed as an integral body including the plate-shaped part 34 and has a rectangular outer shape. However, as a rectangular-shaped hollow woven part, it may have a rectangular outer shape only when it is woven and thus, after woven, the portion of the plate-shaped part may be cut out. Here, when the portion of the plate-shaped part is cut out, the cut-out portion may preferably be closed by a separate fabric member. Of course, the cut-out portion may not be closed by a separate fabric member but it may also be used as a connecting opening part or an inner tube to be provided inside the connecting opening part.

What is claimed is:

1. A head protection air bag that is folded and stored into an upper edge of a window disposed on an vehicle inside of a vehicle, an upper edge of the head protection air bag being fixed to a body of the vehicle, and the head protection air bag being developed and inflated to cover the vehicle inside of the window on receiving an inflating gas from an inflator while projecting downward from a storage portion, the head protection air bag comprising:
an inflating and covering part configured to be inflated to separate a vehicle inside wall situated on the vehicle inside and a vehicle outside wall situated on a vehicle outside from each other on receiving the inflating gas to cover the vehicle inside of the window;
multiple mounting parts projecting upward from an upper edge of the inflating and covering part for mounting the upper edge of the inflating and covering part onto the upper edge of the window; and
a substantially cylindrical-shaped connecting opening part projecting upward from the upper edge of the inflating and covering part, having a leading end so opened as to enable connection of the inflator, and connectable to the inflator, wherein:
the mounting parts and the connecting opening part are formed separately from the inflating and covering part and are mounted onto the inflating and covering part;
a hollow woven bag part, formed by hollow weaving, and a sewn part, formed by sewing a vehicle inside sheet constituting the vehicle inside wall and a vehicle outside sheet constituting the vehicle outside wall to each other, are arranged serially in the vertical direction;
the hollow woven bag part and the sewn bag part are sewn and connected to each other to form the inflating and covering part as a bag-shaped member;
the hollow woven bag part constitutes an upper portion of the inflating and covering part; and
the hollow woven bag part has a rectangular outer shape when the vehicle inside wall and the vehicle outside wall are put on each other and are developed flat.

2. The head protection air bag according to claim 1, wherein
the lower edge of the hollow woven bag part is sewn to the upper edge of the sewn bag part while the lower edge of the hollow woven bag part is put on the inside of the upper edge of the sewn bag part.

3. The head protection air bag according to claim 1, wherein
the vehicle inside and outside sheets of the sewn bag part are made of non-coat fabrics.
